(19) United States
(12) Patent Application Publication
(10) Pub. No.: US 2020/0272757 A1
(43) Pub. Date: Aug. 27, 2020

(54) Securing a Computer Processing Environment from Receiving Undesired Content

(71) Applicant: Lokawallet, Inc., San Jose, CA (US)

(72) Inventors: Roger T. Huitt, Soquel, CA (US); Qing Wang, Palo Alto, CA (US)

(21) Appl. No.: 16/286,017

(22) Filed: Feb. 26, 2019

(51) Int. Cl. G06F 21/62; G06F 21/56; G06F 21/53; H04L 29/06

(52) U.S. Cl. CPC G06F 21/6245; H04L 63/14; G06F 21/53; G06F 21/566

(57) ABSTRACT

The present disclosure is directed to protecting a primary computing environment from receiving undesired content by communicatively disabling communication signals and by controllably enabling specific communication signals. Methods and apparatus consistent with the present disclosure may communicatively isolate a primary computing environment from a secondary computing environment when test are performed on data received via the secondary computing environment are received. This secure protocol may only pass tested computer data to the primary computing environment. Secure protocols consistent with the present disclosure may communicatively isolating a primary computing environment at a particular computing device from data received via another computing environment at that particular computing device. Methods and apparatus consistent with the present disclosure may isolate different portions of a computing device in different ways. This may be accomplished by opening physical electrical connections using switches or may be

### BACKGROUND OF THE INVENTION

### Field of Invention

The present invention generally relates to protecting a primary computing device from receiving unsafe digital content. More specifically the present invention is directed to evaluating digital content before it is provided to a primary computing device.

### Description of the Related Art

One of the greatest threats to privacy and to secure computer data are various sorts of undesired content that can compromise computer data. For example computer malware, computer viruses, and eavesdropping software have been used to steal sensitive information, destroy computer data, and hold computer data for ransom. Another problem that affects computing devices is the dissemination of undesired advertisements and messages. Damage from such “spam” messages or malware are not limited to time lost sorting through these undesired messages, yet also can include “phishing” attacks that can steal personal information or attacks like the “I Love You” virus that spawn excessive email traffic with the intent to crash a computer network.

Generally malware can be any software program that includes code that executes without the knowledge or authorization of an owner or user of a computing device. Malware is typically distributed by parties with nefarious intent. Malware is commonly used steal or destroy computer data or to snoop or spy the actions of a user when the user operates a computer. Malware is also frequently used to damage a computer or to damage computer data. For example malware may be used to steal personal or financial information, blackmail computer users by denying access to their own data unless or until a fee is paid, or to damage infected computers by damaging data stored on those infected computers.

Malware broadly refers to malicious software designed to infiltrate and/or damage a computer system and/or network without the informed, or knowledge of an owner of a computer or computer network.

Recently, computing devices have begun to act as digital wallets that perform transactions with other computing devices that may reside in a store. For example, individuals may use their cell phone to interact and make purchases with a kiosk at a store using wireless transmissions. These digital wallets, however, are at risk from hackers that may use devices to surreptitiously access data stored at a digital wallet using wireless communications.

Because of the threats posed to computing devise in general and to digital wallets, new methods and apparatus are needed to secure these computing devices and digital wallets from exploitation by various forms of undesired content.

### SUMMARY OF THE CLAIMED INVENTION

The presently claimed invention relates to a method, a non-transitory computer readable storage medium, or an apparatus/system that performs functions consistent with the present disclosure. A method consistent with the present disclosure may receive data sent to a primary computing environment, perform a test on that received data, identify that the received data can be provided to the primary computing environment based on a test result from the test, and provide the data to the primary computing environment via an intelligent switch that is configured to send communications between the intelligent switch and the primary computing environment.

When the method of the presently claimed invention is performed by a non-transitory computer readable storage medium, a processor executing instructions out of a memory may also receive data sent to a primary computing environment, perform a test on that received data, identify that the received data can be provided to the primary computing environment based on a test result from the test, and provide the data to the primary computing environment via an intelligent switch that is configured send communications between the intelligent switch and the primary computing environment.

A system consistent with the present disclosure may include a primary computing environment, a secondary computing environment and an intelligent switch. In such a system, the intelligent switch may receive data sent to a primary computing environment, perform a test on that received data, identify that the received data can be provided to the primary computing environment based on a test result from the test, and provide the data to the primary computing environment via an intelligent switch that is configured send communications between the intelligent switch and the primary computing environment.

### BRIEF DESCRIPTION OF THE DRAWINGS

FIG. 1 illustrates an exemplary method consistent with the present disclosure where an intelligent switch may isolate a primary computing environment from a secondary computing environment.

FIG. 2A illustrates a configuration where three different components of a system are communicatively disconnected/isolated from each other.

FIG. 2B illustrates an exemplary configuration consistent with the present disclosure.

FIG. 2C illustrates a second exemplary configuration consistent with the present disclosure.

FIG. 3 illustrates exemplary switches that may be used to connect an intelligent switch to either a secondary environment or a primary environment.

FIG. 4 illustrates an exemplary flow of actions consistent with the present disclosure that may be performed when a user wishes to access content from a remote computing device.

FIG. 5 illustrates a computing system that may be used to implement an embodiment of the present invention.

### DETAILED DESCRIPTION

The present disclosure is directed to protecting a primary computing environment from receiving undesired content by communicatively disabling communication signals and by controllably enabling specific communication signals. Methods and apparatus consistent with the present disclosure may communicatively isolate a primary computing environment from a secondary computing environment when test are performed on data received via the secondary computing environment are received. This secure protocol may only pass tested computer data to the primary computing environment. Secure protocols consistent with the present disclosure may communicatively isolating a primary computing environment at a particular computing device from data received via another computing environment at that particular computing device. Methods and apparatus consistent with the present disclosure may isolate different portions of a computing device in different ways. This may be accomplished by opening physical electrical connections using switches or may be accomplished by disabling wireless communications between elements of an apparatus.

In certain instances, electrical signals that can communicate computer data are physically opened to prevent data from being transmitted from one part of a computing device to another part of that computing device. Alternatively or additionally, communicative coupling between different parts of a computing system may be interrupted by disabling one or more wireless communication channels of a computer system such that one part of a computing device is communicatively isolated from another part of that computing device.

Methods and apparatus consistent with the present disclosure may protect a computing device by using a physical barrier that prevents malware, viruses, or spam from being received by a particular operating environment within the computing device. In such an instance, such a primary computing environment may include logic that is isolated from another environment at that computing device by a set of switches. As such, apparatus and methods consistent with the present disclosure may include an intelligent switch that isolates a primary environment from being directly accessed by a second operating environment. Intelligent switches consistent with the present disclosure may include hardware logic, hardware processors, or combinations of hardware logic and hardware processors. Such intelligent switches may include three different switch configurations that may be referred to as a “left position,” a “neutral position,” and “right position.”

Apparatus consistent with the present disclosure may include a primary computing device that forms the primary environment, the intelligent switch, and a secondary device that forms the secondary environment. In certain instances, the primary environment or the secondary environment may also include hardware logic, hardware processors, or combinations of hardware logic and hardware processors. The secondary device may be configured to receive communications from computing devices via a computer network or may be configured to receive data from a connectable memory, such as a universal serial bus (USB) connectable memory stick.

Functions that may be performed by apparatus and methods consistent with the present disclosure may provide an “air-gap” that isolates such a primary environment from a secondary environment, where computer data cannot be passed to the primary environment until it has been tested by logic/processing logic at an intelligent switch. The analysis of received computer data may be performed at the intelligent switch when the intelligent switch is disconnected from both the primary environment and the secondary environment. The intelligent switch may include physical switches that controllably connect the intelligent switch to the secondary environment, to the primary environment, or to neither the primary or the secondary environment. These physical switches may be implemented using one or more sets of field effect transistors (FETS), each set of FETS may connect one or more signals to the intelligent switch. Switches consistent with the present disclosure may include a control input that causes a first set or a second set of switches to be connected to logic/processing logic at the intelligent switch. Signals switched by such an intelligent switch may include interconnections associated with any type of standard or non-standard electrical interface, including parallel interfaces or serial interfaces known in the art. In certain instances, proprietary communication techniques may be used. Communications between an intelligent switch and a primary or a secondary environment may also be encoded. For example, communication techniques such as modified frequency modulation (MFM) encoding, run length limited (RLL) encoding may be used, hashing data according to a hash function, or encrypting data using various techniques.

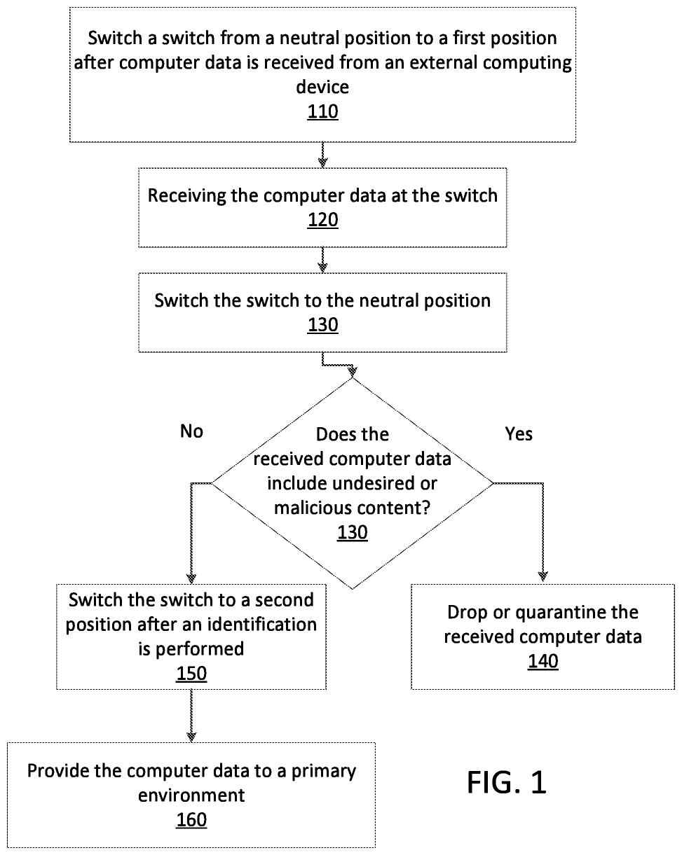

FIG. 1 illustrates an exemplary method consistent with the present disclosure where an intelligent switch may isolate a primary computing environment from a secondary computing environment. FIG. 1 includes step 110, where an intelligent switch may be switched from a neutral position to a first position that connects the intelligent switch to a secondary environment after computer data has been received at the secondary environment. Next in step 120, the computer data received by the secondary environment may be received at the intelligent switch. After step 120, the switch may be switched to a neutral position in step 130 of FIG. 1. This neutral position may be communicatively or electrically isolated from both the primary environment and from the secondary environment.

Next in determination step 140, the intelligent switch may identify whether the received computer includes malicious content. The determination performed in step 140 may be performed by an analysis that detects undesired content, spam or malware. Such an identification may be performed using pattern matching, deep packet inspection, or any other technique known in the art. Determination step 140 may also filter received content using blacklists or whitelists, where computer data from senders in a blacklist are blocked or where computer data from senders in a whitelist are allowed to be passed.

When determination step 140 identifies that the received computer data includes undesired content or malware, program flow may move to step 150 where the computer data may be dropped or quarantined. When determination step 150 identifies that the received computer data does not include the undesired content or malware, program flow may move to step 160 where the intelligent switch is switched to a position that connects the intelligent switch to secondary position that connects the intelligent switch to the primary environment. After step 160, program flow may move to step 170 where the computer data may be passed to the primary environment. Although not illustrated in FIG. 1, images, video, audio, or other information may be provided to a user associated with the primary environment via a display or speaker. Alternatively or additionally the computer data may be provided to a processor at the primary environment for further processing.

Switches or intelligent switches consistent with the present disclosure may frequently be isolated from other computing environments in what may be referred to as a neutral position or configuration. Such switches in this neutral position or configuration may isolate components that perform tests on computer data, where these tests are performed by digital logic or are performed by a processor that executes instructions out of a memory. Functionality associated with intelligent switches may be fixed after intelligent an intelligent switch is fabricated. As such, the functionality of an intelligent switch may be programmed one (using a one-time programmable memory/read only memory), may be set using a mask read only memory (ROM), may be implemented by digital logic associated with a field programmable gate array (FPGA) coupled to a one-time only memory/ROM, or may be implemented by other forms of digital logic known in the art. Furthermore, an intelligent switch consistent with the present disclosure may spend most of its time in the neutral position and may be an only path (vector) through which received data may be passed to a preferred environment.

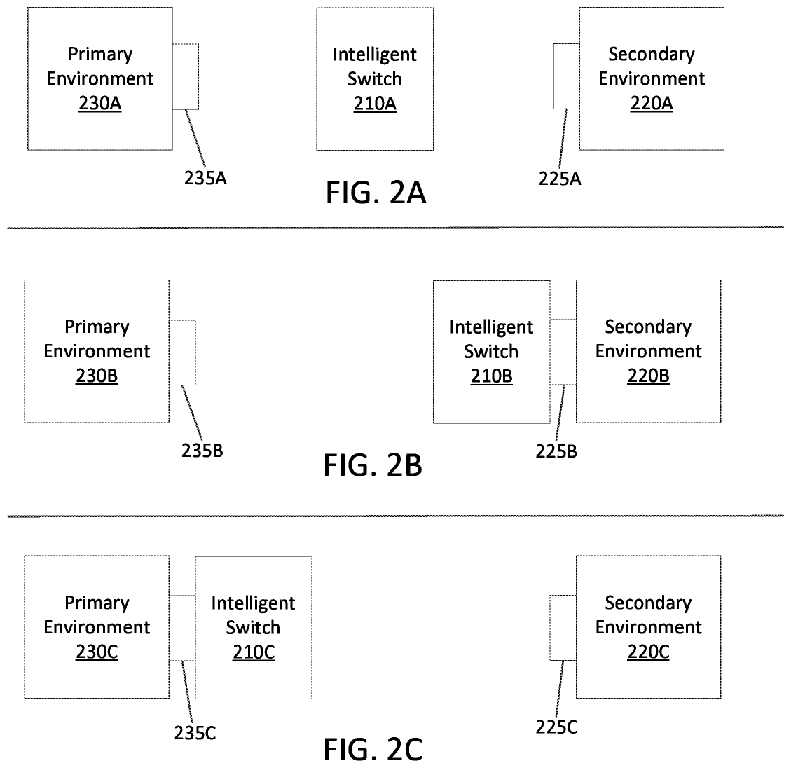

FIG. 2A, 2B, and 2C conceptually illustrate different connection configurations consistent with the present disclosure. FIG. 2A illustrates a configuration where three different components of a system are communicatively disconnected/isolated from each other. The configuration of FIG. 2A may be referred to as a neutral configuration because intelligent switch 210A is not communicatively coupled to secondary environment 220A or to primary environment 230A. The system of FIG. 2A, 2B, and 2C may be incorporated into a single computing device, where intelligent switch 210A, secondary environment 220A, and primary environment 230A may be contained within a single enclosure. Alternatively, intelligent switch 210A, secondary environment 220A, and primary environment 230A may be included in one or more separate devices.

FIG. 2A includes intelligent switch 210A, secondary environment 220A, interconnection 225A, primary environment 230A, and interconnection 225B. Note that switch 210A is communicatively disconnected from both secondary environment 220A and from primary environment 230A. In such a configuration, intelligent switch 210A may be separated from secondary environment 220A and primary environment 230A by an “air-gap.” Such air-gaps may prevent the intelligent switch from being physically electrically connected to secondary environment 220A or primary environment 230A. Physical interconnections 225A and 235A may allow intelligent switch 210A to be connected to secondary environment 220A or primary environment 230A by switches that form direct electrical connections where certain electrical conductors may form a communication pathway between intelligent switch 210A and secondary environment 220A, for example. These electrical conductors may be electrically connected by a switch that may include a transistor, field effect transistor (FET), a relay, or other switching device. In certain instances, these switches may connect a parallel communication bus or a serial communication connection. Parallel communication buses or serial communication connections may be implemented using any standard or non-standard communication bus known in the art. As such, parallel communications may be performed using any interface including, yet not limited to a local communication bus, a peripheral communication (PCI) bus, an Ethernet connection, a universal serial bus (USB), PCI express (PCIe), or other form of direct communication connection.

While methods and systems consistent with the present disclosure may use direct electrical interconnections, other embodiments may use wireless communication interfaces that may be turned off. In such instances, these wireless communication interfaces may be disabled by a switch, for example by a switch that turns off power to electronics associated with a wireless transmitter or receiver could disable reception or transmission of wireless signals. Alternatively a wireless transmission device or antenna may simply be switched out of a circuit when an communication pathway is disabled.

FIG. 2B illustrates an exemplary configuration consistent with the present disclosure. FIG. 2B includes intelligent switch 210B, secondary environment 220B, interconnection 225B, primary environment 230B, and interconnection 235B. FIG. 2B illustrates a configuration where intelligent switch 210B is communicatively coupled to secondary environment 220B and is not communicatively coupled to primary environment 230B. Communications between intelligent switch 210B and 220B may be initiated after secondary environment 220B has received data from an external computer or from a connectable memory device like a USB memory stick. In such an instance, secondary environment 220B and intelligent switch 210B may include a secondary communication mechanism (not illustrated) that may inform intelligent switch 210A that computer data has been received from an external computer. Alternatively, intelligent switch 210B may periodically connect with secondary environment 220B to check whether secondary environment 220B has received any new computer data that needs to be tested before it can be passed to primary environment 230B.

When intelligent switch 210B and secondary environment 220B are communicatively connected via interconnect 225B, intelligent switch 210B may receive the computer data from secondary environment 220B. After this point in time, intelligent switch 210B may test the received computer data to see if it contains undesired content. Intelligent switch 210B may perform tests that include pattern matching, whitelist/blacklist comparisons, and or other tests capable of detecting malware, viruses, or spam. Tests performed by Intelligent switch 210B may be performed in the neutral configuration illustrated in FIG. 2A or may be initiated with intelligent switch is receiving information from secondary environment 220B.

In an instance when the tests performed by an intelligent switch identify that computer data received from a secondary environment do not include undesired content, that switch may be communicatively coupled to a primary environment in a configuration illustrated in FIG. 2C, for example.

FIG. 2C illustrates a second exemplary configuration consistent with the present disclosure. FIG. 2C illustrates that intelligent switch 210C is communicatively coupled to primary environment 230C via interconnect 235C. FIG. 2 also illustrates that intelligent switch 210C and secondary environment 220C are not communicatively coupled via interconnect 225C. In the configuration of FIG. 2C, primary environment 230C may receive computer data only after intelligent switch 210C has tested received computer data and identified that the received computer data does not include undesired content. Functionality associated with intelligent switches may be fixed after intelligent an intelligent switch is fabricated. As such, the functionality of an intelligent switch may be programmed one (using a one-time programmable memory/read only memory), may be set using a mask read only memory (ROM), may be implemented by digital logic associated with a field programmable gate array (FPGA) coupled to a one-time only memory/ROM, or may be implemented by other forms of digital logic known in the art.

In an instance where an intelligent switch can sometimes receive communications from a secondary environment via a secondary communication mechanism, that secondary communication mechanism may be disabled (e.g. switched out of the circuit or turned off) when the intelligent switch is communicatively coupled to the primary environment such as the configuration shown in FIG. 2C.

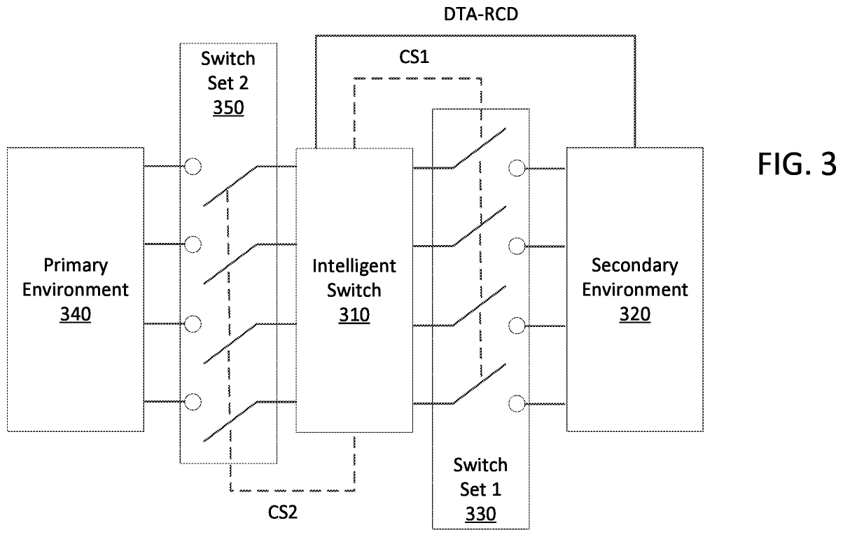

FIG. 3 illustrates exemplary switches that may be used to connect an intelligent switch to either a secondary environment or a primary environment. FIG. 3 includes intelligent switch 310, secondary environment 320, switch set 1 330, primary environment 340, and switch set 2 350. The opening and closing of switches included in switch set 1 330 may be controlled by control signal CS1 and the opening and closing of switches included in switch set 2 350 may be controlled by control signal CS2. Although not illustrated in FIG. 3, secondary environment 320 may include a network interface (wired or wireless) that may receive or send computer data respectively from or to other computing devices.

Control signal CS1 may be used to close the switches of switch set 1 330 to communicatively connect the intelligent switch 310 to the secondary environment 320. Control signal CS2 may be used to close the switches of switch set 2 350 to connect the intelligent switch 310 to primary environment 340. Control signal CS1 may be used to connect the intelligent switch 310 to the secondary environment 320 after data control signal DTA-RCD informs the intelligent switch that computer data has been received by secondary environment 320. Once the switches of switch set 1 330 are closed, communication connections are made such that secondary environment 320 may provide received computer data to intelligent switch 310. At this time primary environment 340 may be protected from hacking, screen-scraping, or key-logging because it is physically isolated from the secondary computing environment and from any external communication path.

After intelligent switch 310 receives the computer data from secondary environment 320, intelligent switch 310 may open the switches of switch set 1 330 and may test the received computer data for undesired content. When intelligent switch 310 identifies that the received computer data does not include undesired content, it may close the switches of switch set 2 350 using control signal CS2. After the switches of switch set 2 350 are closed, intelligent switch 310 may provide the received computer data to primary environment 340. Preferably, switches associated with switch set 1 330 and switch set 2 350 will never be closed at the same time.

In certain instances, logic or processors at a secondary environment may perform a first set of initial tests on received computer data. The secondary environment may be configured to only transmit computer data to an intelligent switch only after this first set of initial test pass.

Various environments consistent with the present disclosure may include different forms of functionality. For example, secondary environments discussed in respect to FIGS. 2-3 may include operating system (OS) software (e.g. AndroidTM compatible OS software), application programs, and one or more data sources (vectors). Such data sources/vectors may include a communication interface wired or wireless, a universal serial bus (USB) port wireless or physical, another secure digital (SD) card, sensors, or other interfaces. A primary environment may include a JAVA OS, a user interface, and user data storage, for example.

Primary environments and secondary environments consistent with the present disclosure may never be physically connected together at any time. A user associated with the primary environment may communicate securely with a second user device operated by a second user. After a message is received in the secondary environment from the second user device, an intelligent switch may be communicatively coupled to the secondary environment after which content included in the received message may be tested an provided to the primary environment securely according to the switching configurations and testing discussed in respect to FIGS. 1-3.

The functionality of a secondary environment and an intelligent switch may be combined, when desired. In such instances, a switch set may isolate functions of an intelligent switch from the secondary environment via switches. While the ability to isolate an intelligent switch from a secondary environment and from a primary environment may be preferred, alternative embodiments may couple the secondary environment to the intelligent switch without switches. This may include coupling the secondary environment to the intelligent switch via a proprietary communication interface or by using a proprietary communication technique. In such instances, the primary environment may only receive computer data after it has been tested and after a connection has been formed via operation of the intelligent switch that allows the primary environment to receive the tested computer data.

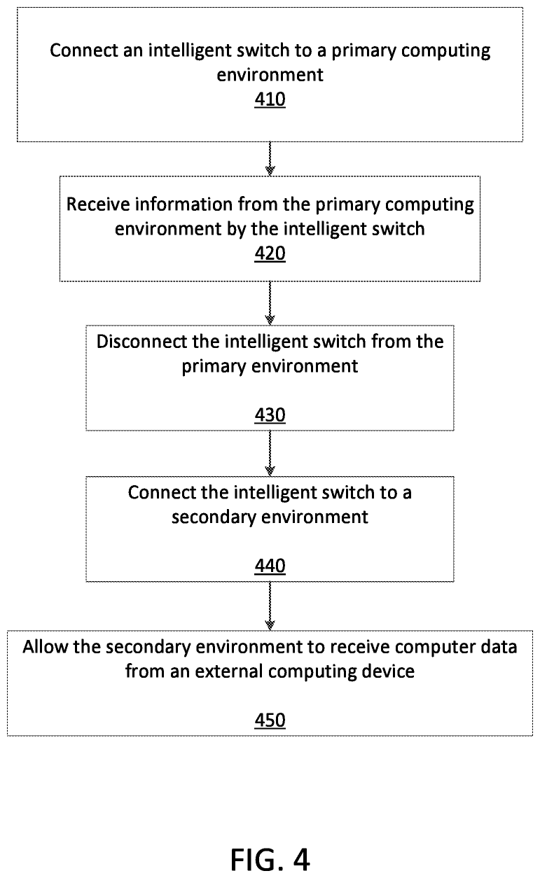

FIG. 4 illustrates an exemplary flow of actions consistent with the present disclosure that may be performed when a user wishes to access content from a remote computing device. In such an instance access requests from the primary environment may be passed to the intelligent switch, such that the intelligent switch may cause a processor associated with the secondary environment to access a website at the Internet, for example. Step 410 of FIG. 4 is where an intelligent switch switches from a neutral position where it may not be communicatively coupled to any other environment to being communicatively coupled to a primary computing environment. This communicative coupling may be implemented by switching one or more switches that make physical electrical interconnections or that enable or disable the coupling of data. Alternatively, communications between the primary environment and the intelligent switch may be performed via wireless communications. The enabling of communications between the primary environment and the intelligent switch may be performed periodically or may be performed based on a communication sent by a secondary means from the primary environment to the intelligent switch. Here again a secondary communication means may include a single communication signal that switches state.

After the intelligent switch connects the primary environment to the intelligent switch in step 410, information from the primary environment may be received by the intelligent switch at step 420 of FIG. 4. The information received from the primary environment may be a request to access information at a server or website. Such a request could include or be related to accessing information associated with a universal resource locator (URL), for example. The intelligent switch may then disconnect from the primary environment in step 430 and then connect to the secondary environment in step 440 of FIG. 4.

After step 440, the secondary environment may be allowed to access data from an external computing device. For example, a URL provided with a request received from the primary environment in step 420 may be accessed by the secondary environment. The actions illustrated in FIG. 4 may precede actions illustrated in FIG. 1. For example, the computer data received at the switch in step 120 of FIG. 1 may be the data accessed in step 440 of FIG. 4 by the secondary environment.

As such, intelligent switches consistent with the present disclosure may selectively connect to either a primary or to a secondary computing environment based on a protocol that may include periodic switching, secondary communications, or proprietary communications that can cause the primary computing environment to always be disconnected/isolated from the secondary computing environment. By doing this, method and apparatus consistent with present disclosure constitute a new form of “air-gapping” specific parts of an overall computing system when performing a security function.

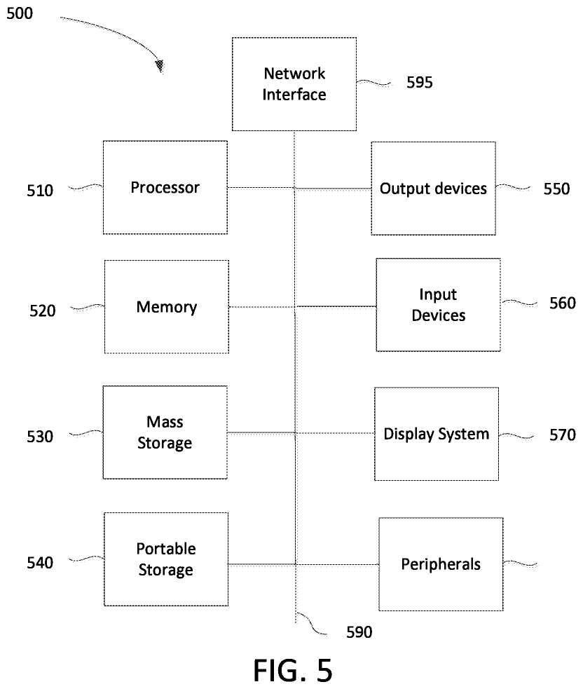

FIG. 5 illustrates a computing system that may be used to implement an embodiment of the present invention. The computing system 500 of FIG. 5 includes one or more processors 510 and main memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, peripheral devices 580, and network interface 595.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a FLASH memory, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

Network interface 595 may include any form of computer interface of a computer, whether that be a wired network or a wireless interface. As such, network interface 595 may be an Ethernet network interface, a BlueTooth™ wireless interface, an 802.11 interface, or a cellular phone interface.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, FLASH memory, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for providing computer security, the method comprising:
receiving data at an intelligent switch from a secondary computing environment that originated from an external computing device and that was sent to a primary computing environment;
performing a test on the data sent to the primary computing environment;
identifying that the data sent to the primary computing environment can be provided to the primary computing environment based on a test result associated with the test; and
providing the data to the primary computing environment based on the test result, the data provided after the intelligent switch is configured to send communications between the send communications between the intelligent switch and the primary computing environment.

2. The method of claim 1, further comprising:
communicatively coupling the intelligent switch to the secondary computing environment by enabling one or more communication signals to pass between the secondary computing environment and the intelligent switch; and
disabling the one or more communication signals between the secondary computing environment and the intelligent switch before the intelligent switch is configured to send communications to the primary computing environment.

3. The method of claim 1, further comprising:
transitioning a switching configuration at the intelligent switch from a neutral position to a primary configuration where communications can be sent between the primary computing environment and the intelligent switch;
receiving a request from the primary computing environment; and
transitioning the switching configuration at the intelligent switch to a second switching configuration that does not connect the primary computing environment to the intelligent switch and that connects the intelligent switch to the secondary computing environment, thereby, allowing the intelligent switch to pass the request request to the secondary computing environment based on the second switching configuration, wherein the second computing environment receives data from an external computer according to the request.

4. The method of claim 3, further comprising receiving at the intelligent switch data associated with the request.

5. The method of claim 4, further comprising transitioning the switching configuration at the intelligent switch to a neutral position that isolates the intelligent switch from a first signal associated with the primary computing environment and from a second signal associated with the secondary computing environment.

6. The method of claim 1, wherein the test is performed when the intelligent switch is in a neutral position that isolates the primary computing environment from the secondary computing environment.

7. The method of claim 1, wherein the secondary computing environment performs one or more other tests on the data that originated from the external computing device before that original data is received by the intelligent switch.

8. A non-transitory computer readable storage medium that performs a method for providing computer security, the method comprising:
receiving data at from a secondary computing environment that originated from an external computing device and that was sent to a primary computing environment;
performing a test on the data sent to the primary computing environment;
identifying that the data sent to the primary computing environment can be provided to the primary computing environment based on a test result associated with the test; and
providing the data to the primary computing environment based on the test result, the data provided after an intelligent switch is configured to send communications between the primary computing environment and the intelligent switch.

9. The non-transitory computer readable storage medium of claim 8, the program further executable to:
communicatively couple the intelligent switch to the secondary computing environment by enabling one or more communication signals to pass between the secondary computing environment and the intelligent switch; and
disable the one or more communication signals between the secondary computing environment and the intelligent switch before the intelligent switch is configured to send communications to the primary computing environment.

10. The non-transitory computer readable storage medium of claim 8, the program further executable to:
transition a switching configuration at the intelligent switch from a neutral position to a primary configuration that sends communications between the primary computing environment and the intelligent switch;
receive a request from the primary computing environment; and
transition the switching configuration at the intelligent switch to a second switching configuration that does not connect the primary computing environment to the intelligent switch and that connects the intelligent switch to the secondary computing environment, thereby, allowing the intelligent switch to pass the request to the secondary computing environment based on the second switching configuration, wherein the second computing environment receives data from an external computer according to the request.

11. The non-transitory computer readable storage medium of claim 10, the program further executable to receive data associated with the request.

12. The non-transitory computer readable storage medium of claim 11, the program further executable to transition the switching configuration at the intelligent switch to a neutral position that isolates the intelligent switch from a first signal associated with the primary computing environment and from a second signal associated with the secondary computing environment.

13. The non-transitory computer readable storage medium of claim 8, wherein the test is performed when the intelligent switch is in a neutral position that isolates the primary computing environment from the secondary computing environment.

14. The non-transitory computer readable storage medium of claim 8, wherein the secondary computing environment performs one or more other tests on the data that originated from the external computing device before that original data is received by the intelligent switch.

15. A system for providing computer security, the system comprising:
a primary computing environment;
a secondary computing environment; and
an intelligent switch that:
receives data at from a secondary computing environment that originated from an external computing device and that was sent to a primary computing environment,
performs a test on the data sent to the primary computing environment,
identifies that the data sent to the primary computing environment can be provided to the primary computing environment based on a test result associated with the test, and
provides the data to the primary computing environment based on the test result, the data provided after the intelligent switch is configured to send communications between the primary computing environment and the intelligent switch.

16. The system of claim 15, further comprising a first set of one or more switches that communicatively couple the intelligent switch to the secondary computing environment by enabling one or more communication signals to pass between the secondary computing environment and the intelligent switch, wherein the one or more communication signals between the secondary computing environment and the intelligent switch are disabled before the intelligent switch is configured to send communications to the primary computing environment.

17. The system of claim 15, further comprising a second set of one or more switches that transitions a switching configuration at an intelligent switch from a neutral position to a primary configuration where communications can be sent between the primary computing environment and the intelligent switch to receive a request is received from the primary computing environment, wherein:
the switching configuration at the intelligent switch is transitioned to a second switching configuration that does not connect the primary computing environment to the intelligent switch and that connects the intelligent switch to the secondary computing environment, thereby, allowing the intelligent switch to pass the request to the secondary computing environment based on the second switching configuration, and
the second computing environment receives data from an external computer according to the request.

18. The system of claim 17, wherein data is received at the intelligent switch that is associated with the request.

19. The system of claim 18, wherein the switching configuration at the intelligent switch is switched to a neutral position that isolates the intelligent switch from a first signal associated with the primary computing environment and from a second signal associated with the secondary computing environment.

20. The system of claim 15, wherein the test is performed when the intelligent switch is in a neutral position that isolates the primary computing environment from the secondary computing environment.
